(19) United States
(12) Patent Application Publication
(10) Pub. No.: US 2014/0333536 A1
(43) Pub. Date: Nov. 13, 2014

(54) SCROLL WHEEL WITH DETENT

(71) Applicant: MICROSOFT CORPORATION, Redmond, WA (US)

(72) Inventors: MinLi Tee, Shenzhen (CN); Yujian Peng, Shenzhen (CN); Zhigao Guo, Shenzen (CN)

(73) Assignee: Microsoft Corporation, Redmond, WA (US)

(21) Appl. No.: 13/891,486

(22) Filed: May 10, 2013

(51) Int. Cl. G06F 3/0354

(52) U.S. Cl. CPC G06F 3/03543
USPC 345/163

(57) ABSTRACT

An input device for use with a computing device includes a ball, a spring configured to encircle at least a portion of the ball, and a scroll wheel having an outer circumferential surface configured to be contacted by a digit of a user and having an inner circumferential surface having formed thereon a plurality of protrusions spaced substantially evenly from one another. The spring is configured to exert an upward force on the ball against at least one of the plurality of protrusions to provide a detent to the scroll wheel.

### TECHNICAL FIELD

This disclosure pertains to a scroll wheel with a detent that resists rotation.

### BACKGROUND

A computing device may receive user input (e.g., cursor control, screen scrolling, and the like) using a variety of input devices, including a mouse. A typical mouse 100 is shown in FIG. 1. Mouse 100 includes a bottom case 102 and an upper case 104. As the user slides mouse 100 across a substantially planar surface, motion detectors and encoders within mouse 100 may convert the two-dimensional movement of the mouse across the planar surface into horizontal and vertical motion of an object, cursor, pointer, or other icon on a screen of the computing device. Mouse 100 includes a right button 106 and a left button 108 that the user may singularly or doubly depress (i.e., click or double click) to select an object on the screen. A person of ordinary skill in the art may recognize that mouse 100 may have fewer or additional buttons, or other features. Mouse 100 may be electrically coupled to the computing device using wired communications, wireless communications, or other communications.

Mouse 100 includes a scroll wheel 110 typically located between right button 106 and left button 108, although other locations are possible. The user will rotate scroll wheel 110 using a digit or finger. The computing device may be configured such that rotating the scroll wheel 110 with a digit or finger causes an object on the screen to scroll upwards or downwards. Scroll wheel 110 may be configured to perform other functions such as moving an object on the screen in a z-direction, changing zoom or other attributes of the object, scrolling the screen horizontally, and the like. Scroll wheel 110 may also be configured to act as a button additional to right button 106 and left button 108 when depressed by the user.

To prevent scroll wheel 110 from rotating undesirably (e.g., when the user is moving mouse 100 but not turning scroll wheel 110), to provide a desired tactile feedback to the user, and/or to provide a means of indexing rotation of scroll wheel 110 into discrete increments, some type of restraint or detent is typically imposed on scroll wheel 110.

Various configurations of restraints exist. U.S. Pat. No. 5,912,661, titled “Z-Encoder Mechanism” and owned by assignee of the present disclosure, describes a restraint in which the detents are located on the axle of a scroll wheel. An improvement upon this restraint is described in U.S. Pat. No. 6,353,429, titled “Detented Optical Encoder” and also owned by the assignee of the present disclosure. Specifically, a plastic bracket contacts the axle near one of its rotational hubs and biases the axle upward so as to provide z-switch functionality. A follower, located within the portion of the bracket cradling the axle, is thereby simultaneously biased into contact with the detents. Further improvements to scroll wheel restraints are possible and will result in attendant improvements to the user experience, as well reliability and manufacturability of mouse 100.

### SUMMARY

This Summary introduces a selection of concepts in a simplified form that are further described below in the Detailed Description. This Summary is not intended to identify key features or essential features of the claimed subject matter, nor is it intended to be used to limit the scope of the claimed subject matter.

An input device for use with a computing device includes a ball, a spring configured to encircle at least a portion of the ball, and a scroll wheel having an outer circumferential surface configured to be contacted by a digit of a user and having an inner circumferential surface having formed thereon a plurality of protrusions spaced substantially evenly from one another. The spring is configured to exert an upward force on the ball against at least one of the plurality of protrusions to provide a detent to the scroll wheel. The ball and the spring are housed in a slot of a housing that, in turn, is coupled to a holder with supports mechanically coupled to a printed circuit assembly. The scroll wheel includes a plurality of spokes configured to emanate radially from a center of the scroll wheel to the inner circumferential surface of the scroll wheel, with a window formed in between a pair of adjacent spokes. An illumination circuit is configured to illuminate the scroll wheel with a light and a sensor is configured to detect the light as it passes through the window.

Additional aspects and advantages of an exemplary scroll wheel with detent will be apparent from the following detailed description that proceeds with reference to the accompanying drawings.

### DRAWINGS DESCRIPTION

FIG. 1 is a diagram of an exemplary mouse.

FIG. 2A is a plan view of an exemplary scroll wheel assembly.

FIG. 2B is a cutout view of a detent for the exemplary scroll wheel assembly shown in FIG. 2A.

FIG. 2C is a first side view of the exemplary scroll wheel assembly shown in FIG. 2A.

FIG. 2D is a second side view of the exemplary scroll wheel assembly shown in FIG. 2A.

FIG. 2E is a top view of the exemplary scroll wheel assembly shown in FIG. 2A.

FIG. 3 is a flowchart of an exemplary method of operating the exemplary scroll wheel assembly shown in FIG. 2A.

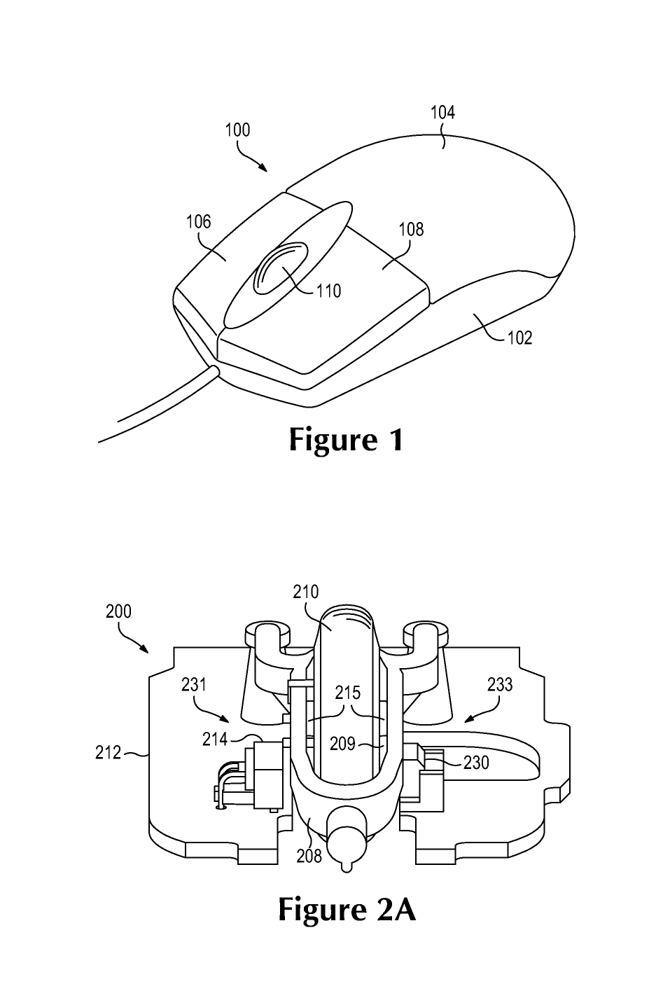

### DETAILED DESCRIPTION

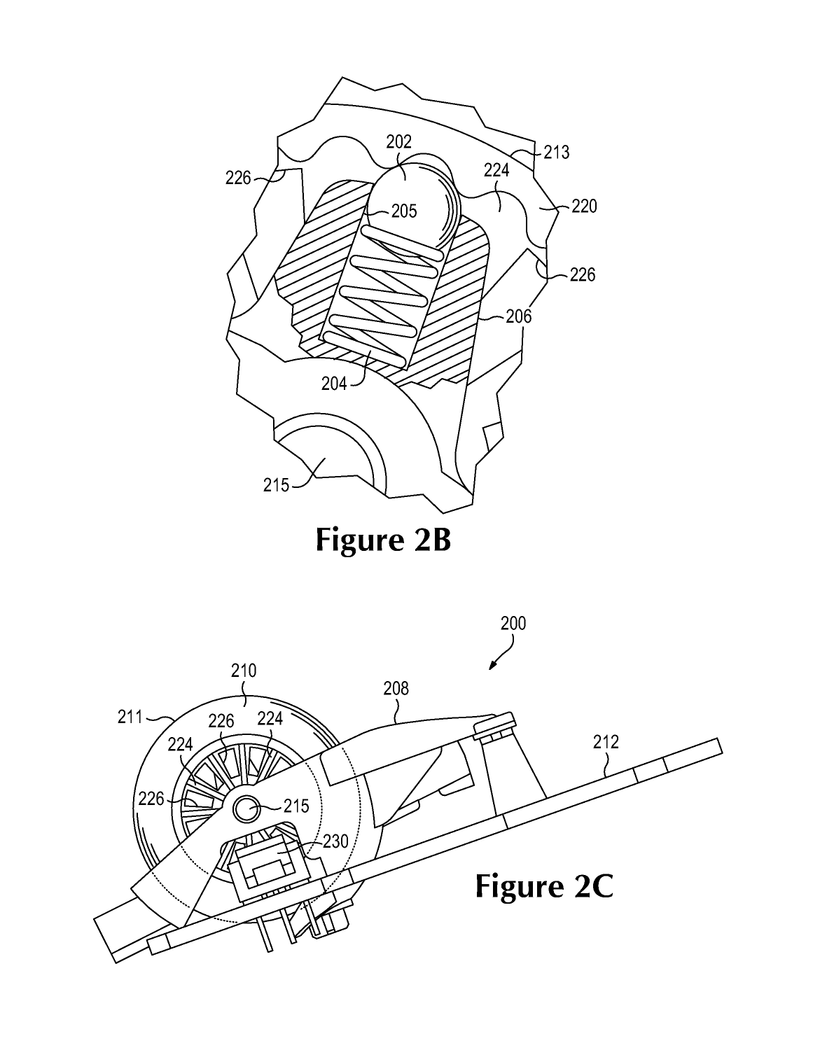

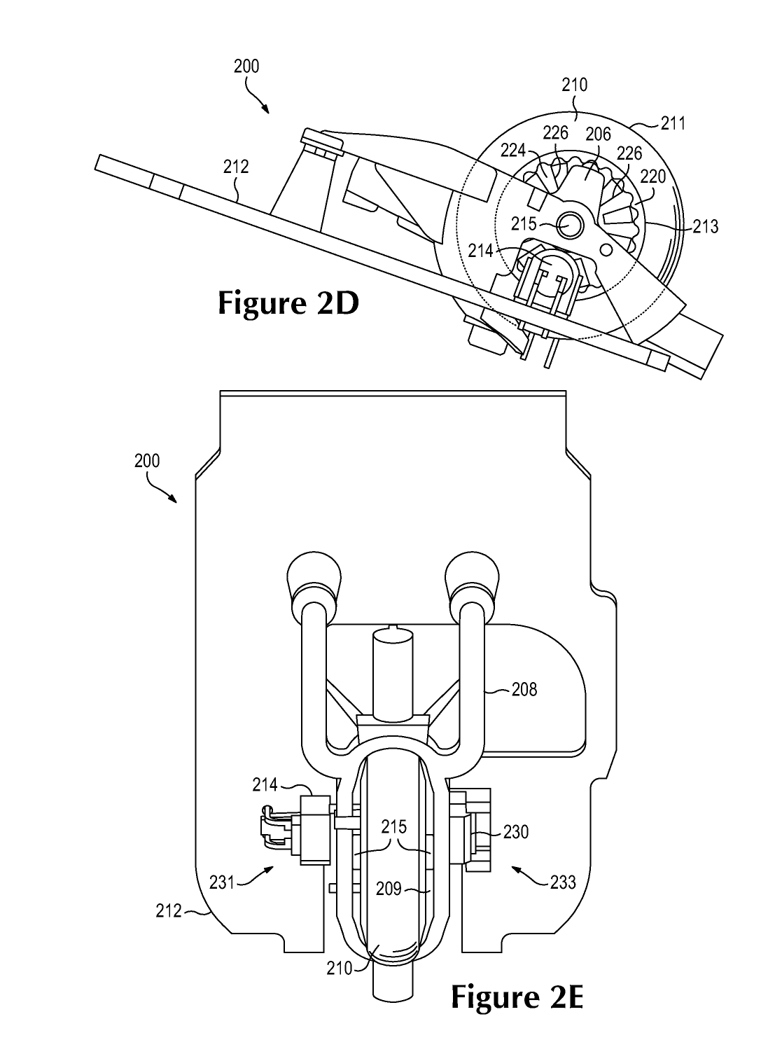

Referring to FIGS. 2A to 2E, scroll wheel assembly 200 may comprise a ball 202 and a spring 204. Ball 202 may include a substantially spherical shape and may be made of any material appropriate for its function, including metal, plastic, and the like. A person of ordinary skill in the art should recognize that the size of ball 202 may vary with design constraints associated with scroll wheel assembly 200, including assembly size, overall assembly shape, and the like. Spring 204 may include a substantially helical or coil shape formed by twisting or coiling wire. Spring 204 may be made of any material appropriate for its function, including metals such as steel, titanium, bronze, and the like and plastics and synthetic polymers such as engineered thermoplastics, e.g., polyoxymethylene. A person of ordinary skill in the art should recognize that the strength of spring 204 may vary to improve the tactile feedback provided to the user causing rotation of scroll wheel 210. Other parameters of spring 204 may vary with design constraints associated with scroll wheel assembly 200. Spring 204 may encircle at least a portion of ball 202 and may exert an upward force on ball 202 proportional to a change in the length of spring 204.

Ball 202 and spring 204 may be housed inside a slot 205 of a housing 206. Slot 205 and housing 206 may be sized to allow for movement vertical or otherwise of ball 202 and spring 204 as they engage a plurality of protrusions, cogs, projections, or teeth 220 in response to rotation of scroll wheel 210. Housing 206 may be mechanically coupled to a holder 208 having supports that extend to printed circuit board 212. Holder 208 may have a cavity 209 configured to house ball 202, spring 204, housing 206, and scroll wheel 210. A person of ordinary skill in the art may recognize that housing 206 and holder 208 may be made of any material appropriate for their function, including metals, plastics, and the like.

Printed circuit board 212 may mechanically support and electrically couple any electronic components, e.g., buttons, of a mouse including scroll wheel assembly 200.

Printed circuit board 212 may include conductive pathways or traces formed from copper sheets laminated onto a non-conductive substrate. In an embodiment, printed circuit board 212 may electrically couple a lamp 214 and a sensor 230 to a power source and other electronic circuits (not shown). A person of reasonable skill in the art may well know the particular materials and processes used to manufacture printed circuit board 212.

Scroll wheel assembly 200 may further comprise a scroll wheel 210 having an outer circumferential surface 211 and an inner circumferential surface 213. Outer circumferential surface 211 may be configured to be contacted by a digit or finger of a user (not shown) to rotate scroll wheel 210 forwards or backwards. Rotation of scroll wheel 210 forwards or backwards may cause an object on a screen of a computing device to scroll upwards or downwards. Rotational movement of scroll wheel 210 may be configured to perform other functions such as moving an object on the screen in a z-direction, changing zoom amount or other attributes of the object, scrolling the screen horizontally forwards or backwards, and the like. Rotation of scroll wheel 210 also may be configured together with other input mechanisms (e.g., mouse buttons or keyboard keys) to cause a variety of functions on a screen of a computing device. Rotational movement of scroll wheel 210 also may be configured to act as a button additional to other buttons that may exist on the mouse that includes scroll wheel assembly 200.

Outer circumferential surface 211 may include a texture to improve the tactile feel of scroll wheel 210 to the user and thereby allow for easier rotational movement by the user's digit or finger.

Substantially evenly spaced along inner circumferential surface 213 are a plurality of protrusions 220 that include a series of peaks and troughs. The plurality of protrusions 220 may have rounded peaks and troughs as shown in FIG. 2B but may also have other shapes. The plurality of protrusions 220 may be formed on the inner circumferential surface 213 of a first side 231 of scroll wheel 210 or on a first side of a plurality of spokes 224. The plurality of protrusions 220 alternatively may be formed on second side 233 of scroll wheel 210 or a second side of the plurality of spokes 224 or both the first side 231 and the second side 233.

As scroll wheel 210 rotates under the direction of a user, ball 202 rides along protrusions 220 that, in turn, cause spring 204 to flex downward to thereby create a detent or restraint to rotation of scroll wheel 210. The force required to rotate scroll wheel 210 and thus move ball 202 from one detent position to the next (or from one protrusion to the next) may vary depending on the strength of spring 204 (since the strength of spring 204 may regulate its vertical displacement) as well as the shape of protrusions 220. The force to rotate scroll wheel 210 may vary for many other reasons including materials used to make ball 202, spring 204, protrusions 220, and the like. The force to rotate scroll wheel 210 may vary with the presence of lubricant. A person of reasonable skill in the art should recognize that these and other factors may be manipulated, changed, or otherwise considered to improve the overall operation of the mouse that includes scroll wheel assembly 200.

Axle 215 is movably coupled to scroll wheel 210, which coupling may be strengthened by the plurality of spokes 224. Spoke 224 may extend radially from a center of scroll wheel 210 to a center of inner circumferential surface 213, with the plurality of protrusions 220 formed on side 231 of scroll wheel 210. Spoke 224 may be substantially evenly-spaced from adjacent spokes 224. A plurality of windows 226 may exist between a pair of adjacent spokes 224. Scroll wheel 210, the plurality of spokes 224, and/or axle 215 may be molded to form a single integral component.

After assembly, at least a portion of scroll wheel 210 rests inside cavity 209 of holder 208. Holder 208 and housing 206 may each or both be a single integral piece made of any material suitable for its function including plastics and metals. Housing 206 may be held in place between holder 208 and scroll wheel 210 by holder 208. Alternatively, housing 206 may snap into axle 215 alongside scroll wheel 210 before scroll wheel 210 is located within cavity 209. Although holder 208 is shown as surrounding axle 215, other configurations are possible including a configuration in which holder 208 includes a slot such that axle 215 snaps into holder 208. Axle 215 may be movably mechanically coupled to housing 206, holder 208, and scroll wheel 210 to allow scroll wheel 210 to rotate within cavity 209 forwards or backwards under the direction of a user. As scroll wheel 210 rotates about axle 215, ball 202 is allowed to descend into and out of each of the plurality of protrusions 220 in response to the force exerted by spring 204. As ball 202 is forced out of a protrusion 220, ball 202 is pushed radially inward against a radially outward bias of spring 204 to thereby prevent unintended or undesired rotational movement of scroll wheel 210.

As the user rotates scroll wheel 210 with his digit or finger, ball 202 and spring 204 remain in slot 205 of housing 206. A lamp 214 is located on first side 231 of scroll wheel 210 and is configured to illuminate first side 231 of scroll wheel 210. That is, lamp 214 generates a light that illuminates first side 231 of scroll wheel 210. Sensor 230 is located on second side 233 of scroll wheel 210 and may detect the light from lamp 214 as it passes through at least one of the plurality of windows 226 as scroll wheel 210 rotates. The plurality of spokes 224 and the plurality of windows 226 may be spaced to index or measure rotation of scroll 210 such that lamp 214, sensor 230, and the plurality of spokes 224 from an optical encoder circuit. Indexing or measuring allows for mapping rotation of scroll wheel 210 to attendant movements in the object on the screen. Optical encoders such as that comprising lamp 214, sensor 230, and the plurality of spokes 224 are well-known to a person of ordinary skill in the art.

First side 231 of scroll wheel 210 may include the plurality of protrusions 220, ball 202, spring 204, housing 206, and lamp 214. Second side 233 of scroll wheel 210 may include sensor 230. The location of the various components on either side of scroll wheel 210 may change. For example, it is entirely possible to locate sensor 230 on first side 231 and lamp 214 on second side 233 of scroll wheel 210.

When scroll wheel 210 rotates, the plurality of spokes 224 may block the light from lamp 214 while the plurality of windows 226 may pass the light from lamp 214 to sensor 230 to thereby detect rotation of scroll wheel 210. The details of such optical detection are known in the art and will not be discussed herein in any further detail. The plurality of protrusions 220 may be configured so that when ball 202 rests in a trough between protrusions when scroll wheel 210 is at rest, spoke 224 blocks light from lamp 214 from reaching sensor 230. Lamp 214 and sensor 230 may be mechanically mounted directly or through a bracket to printed circuit board 212.

Axle 215 or the plurality of spokes 224 may be integrally formed from any desired plastic or rubber-like material. The described materials are exemplary and other materials or combinations are within the scope of the present disclosure. A small amount of lubricant may be added between axle 215 and scroll wheel 210, between ball 202 and spring 204, or between ball 202 and the plurality of spokes 224.

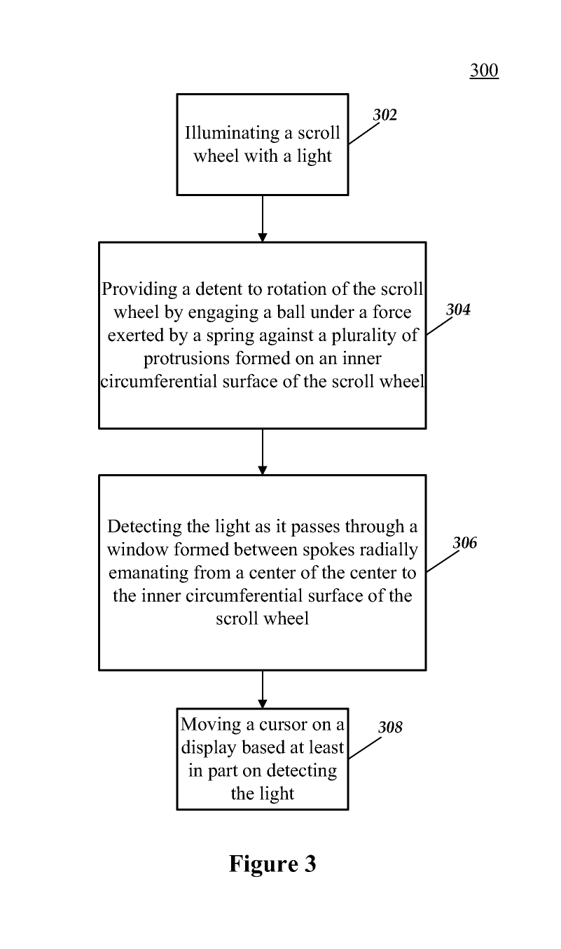

FIG. 3 is a flowchart of an exemplary method of operating scroll wheel 210 with detent.

At 302, a lamp illuminates a first side of a scroll wheel having a plurality of spokes emanating radially from a center of the scroll to an inner circumferential surface.

At 304, a detent or restraint to rotation of the scroll wheel is provided by engaging a ball under a force exerted by a spring against a plurality of protrusions formed on the inner circumferential surface of the scroll wheel. As scroll wheel rotates under the direction of a user, the ball rides or glides along each protrusion that, in turn, cause the spring to flex downward to thereby create a detent to rotation of the scroll wheel 210. The force required to rotate the scroll wheel and thus move the ball from one detent position to the next (i.e., from one protrusion to the next) may vary depending on the strength of the spring since the strength of the spring may regulate its vertical displacement as well as the shape of each of the plurality of protrusions.

At 306, a sensor located on a second side opposite to the first side detects the light as it passes through windows formed between adjacent spokes.

At 308, an object displayed on a screen moves a predetermined distance based on the detection of the light through windows formed between adjacent spokes.

As is clear from the above description, scroll wheel assembly 210 provides numerous advantages over other scroll wheel configurations. Scroll wheel assembly 210 provides a minimum number of parts resulting in tolerances that are easily and accurately maintained. This, in turn, enhances consistency in scroll wheel performance from mouse to mouse. Reducing the number of parts also reduces assembly time and expense. Scroll wheel assembly 210 provides a consistent detent feel for a user rotating scroll wheel 210 in either forwards or backwards directions.

A person of ordinary skill in the art will recognize that they may make many changes to the details of the above-described exemplary scroll wheel with detent without departing from the underlying principles. Only the following claims, therefore, define the scope of the exemplary horizontal scroll wheel.

1. An input device for use with a computing device, comprising:
a ball;
a spring configured to encircle at least a portion of the ball; and
a scroll wheel having an outer circumferential surface configured to be contacted by a digit of a user and having an inner circumferential surface having formed thereon a plurality of protrusions;
wherein the spring is configured to exert an upward force on the ball against at least one of the plurality of protrusions to provide a detent to the scroll wheel.

2. The input device of claim 1, further comprising a support structure including a slot configured to house at least portions of the spring or the ball.

3. The input device of claim 1, wherein the ball comprises a substantially spherical shape.

4. The input device of claim 1, wherein the spring comprises a predetermined strength.

5. The input device of claim 1, wherein the spring comprises a thermoplastic.

6. The input device of claim 1, wherein the plurality of protrusions are spaced substantially evenly from one another.

7. The input device of claim 1, wherein the scroll wheel comprises:
a plurality of spokes configured to emanate radially from a center of the scroll wheel to the inner circumferential surface of the scroll wheel; and
a window formed in between a pair of adjacent spokes.

8. The input device of claim 1, further comprising:
an illumination circuit configured to illuminate the scroll wheel with a light; and
a sensor configured to detect the light as it passes through the window.

9. A mouse configured to move a cursor on a display of a computing device, comprising:
a scroll wheel comprising an outer surface configured to be rotated by a digit of a user and an inner surface comprising a plurality of protrusions formed thereon;
a ball configured to engage with the plurality of protrusions; and
a spring configured to exert a force on the ball against at least one of the plurality of protrusions.

10. The mouse of claim 9, wherein the scroll wheel further comprises:
a plurality of spokes configured to emanate from a center to the inner surface of the scroll wheel; and
a window formed between adjacent spokes.

11. The mouse of claim 10, further comprising:
a lamp configured to provide a light to a first side of the scroll wheel; and
a sensor located on a second side of the scroll wheel and configured to detect the light as the light passes through the window.

12. The mouse of claim 9, further comprising a support structure including a slot configured to house at least a portion of the spring or the ball.

13. The mouse of claim 9, wherein the ball comprises a substantially spherical shape.

14. The mouse of claim 9, wherein the spring comprises a predetermined strength.

15. The mouse of claim 9, wherein the spring comprises a thermoplastic.

16. The input device of claim 1, wherein the plurality of protrusions are spaced substantially evenly from one another.

17. A method, comprising:
illuminating a scroll wheel with a light, the wheel comprising an outer circumferential surface configured to be contacted by a digit of a user and comprising an inner circumferential surface having formed thereon a plurality of protrusions;
providing a detent to rotation of the scroll wheel by engaging a ball against at least some of the plurality of protrusions in response to a force exerted by a spring against the ball;
detecting the light as it passes through a window formed in between adjacent spokes emanating from a center of the scroll wheel to the inner circumferential surface of the scroll wheel based at least in part on rotating the scroll wheel; and
moving a cursor on a display of a computing device a predetermined distance based at least in part on detecting the light.

18. The method of claim 17, wherein the predetermined distance is based at least in part on the ball engaging a predetermined number of the plurality of protrusions as the user rotates the scroll wheel.

19. The method of claim 17, further comprising spacing a plurality of the spokes substantially evenly from one another.

20. The method of claim 17, further comprising:
encircling at least a portion of the ball using the spring; and
supporting at least a portion of the ball or the spring in a slot.
